(19) United States
(12) Patent Application Publication
(10) Pub. No.: US 2021/0357195 A1
(43) Pub. Date: Nov. 18, 2021

(54) Method and System for Executable Smart Legal Contract Construction and Execution over Legal Contracts

(71) Applicant: UNIVERSITY OF SCIENCE AND TECHNOLOGY BEIJING, Beijing (CN)

(72) Inventors: Yan ZHU, Beijing (CN); Di WANG, Beijing (CN); Bohan QIN, Beijing (CN); Weijing SONG, Beijing (CN)

(21) Appl. No.: 17/444,054

(22) Filed: Jul. 29, 2021

Related U.S. Application Data
(63) Continuation-in-part of application No. PCT/CN2020/131917, filed on Nov. 26, 2020.

(30) Foreign Application Priority Data
May 8, 2020 (CN) 202010381549.5

(51) Int. Cl. G06F 8/51; G06F 8/41; G06F 8/60; G06Q 50/18; H04L 9/32

(52) U.S. Cl. CPC G06F 8/51; G06F 8/42; G06F 8/447; H04L 2209/38; G06Q 50/18; H04L 9/3236; G06F 8/60

(57) ABSTRACT

A method for executable smart legal contract construction and execution over legal contracts includes several steps. 1) Use the specified smart contract language to formally represent attributes and terms in natural language contracts, further generate smart contracts. 2) Use the conversion rules over target language to translate the smart legal contracts into executable target language contracts. 3) Each of target language contracts is compiled, further encapsulated as a blockchain transaction which is issued into blockchain via consensus protocol. The deployment of the contracts is completed once the contracting parties sign the target language contracts. 4) Once term of the smart legal contract is triggered, the corresponding functions of the target language contract will be executed by the blockchain nodes, and the execution results are issued to blockchain in a blockchain transaction form. After validation, the transaction is stored into blockchain as an electronic certification of contract execution.

### FIELD OF THE INVENTION

The invention relates to the field of information technology, in particular the smart executable contract construction, execution method and system of legal contract, which are used for information services.

### BACKGROUND OF THE INVENTION

Contract is a contract signed between specific persons, which are ubiquitous in life, and is an agreed-upon framework that allows parties who do not gain mutual trust to arrange rights and obligations. Smart contract is a computer program that uses a programming language to realize a set of commitment expressions, and now refers to a program or script which runs on the blockchain, and has characteristics of automatic execution, tamper proof, traceability, etc. The conversion from traditional contract to smart contract and the improvement of contract form automation, standardization and digitalization will help to promote the electronic development of law, economy, and other aspects.

The current smart contracts are mainly divided into the following three types: script-type smart contract, general-type smart contract and special-type smart contract. Although the platforms and languages of these contracts have become much more mature and functions tend to be perfect, there are still many obstacles in the development, as follows:

1) Low digitization of assets based on blockchain. Smart contract is a program that involves assets and transactions, and a set of available transaction systems have been provided on the blockchain currently. However, the blockchain-based digital assets are still imperfect, and the attempts and researches in this area do not attract public attention;

2) The current smart contract language has a stronger specialty. The current smart contract programming languages are Turing complete languages oriented to programmers, and have a big difference with natural languages. However, the essence of contract services is oriented to the public, generally involving collaboration in multiple fields of computers, laws, finance, etc. Therefore, the existing smart contract languages have a relatively high threshold for non-programmers;

3) A normalized contract architecture oriented to the public is lacking. The traditional contract system has a set of referable standard system or template, and the overall structure of the particular type contract is the same although it is written by different people. In contrast to the current smart contract system, the same type of contracts has different implementation methods and distinct contract expression forms, which not only bring understanding difference, but also bring challenges to the normalization and legal compliance of the follow-up smart contracts.

### SUMMARY OF THE INVENTION

In view of the technical problems existing in the prior art, the invention aims to provide a complete set of an executable smart contract construction for execution method and system of legal contracts from a traditional contract to a smart contract. The system provides a three-layer smart contract system framework comprising a smart legal contract layer, a general smart contract layer and a machine code execution layer based on a traditional contract, and completes the formulation of a standardization framework of the whole process from traditional contract to program codes, machine codes, deployment, execution, etc., as shown in FIG. 1.

Firstly, a smart legal contract language like natural language is provided at a smart legal contract layer, which defines the parties, assets, terms, additional information, etc. It perfects the expression of digital assets and property relations, and provides a readable and friendly contract writing method for non-computer personnel. The language can also specify a corresponding smart legal contract template according to the traditional contract in multiple scenes, which makes it easier to form a standardized smart contract system for the public. In addition, the system automatically converts the smart legal contract written by user into the executable target language contract, then deploys them to the blockchain according to the transaction process. In the actual operation of the contract, this system gives two signature methods for multi-party signatures: the static way of pre-defined party list and dynamic way of joining party in runtime, to meet the needs of various contract signatures in real life.

The definitions of some terms in this patent are given below:

Traditional contract: refers to common paper-based contract which is different from the electric and self-executing agreement, also called natural language contract.

Smart legal contract: has grammatical features of real legal contracts, which is written in a quasi-natural language (called smart legal contract language).

Target language contract: the program developed on the existing blockchain and smart contract platform using the supported programming language (called target language), also known as target language program, including:

1) Script-type smart contract: the smart contract written according to a script instruction system that has been defined in the blockchain, which can complete basic calculation and condition control processes, such as bitcoin script;

2) General-type smart contract: the smart contract adopts traditional programming language, which is deployed in virtual machine or container, and interacts with blockchain through specified interface, such as Java, Go, C#, C++.

3) Special-type smart contract: the smart contract with the language which imitates the structure of traditional program language and adds special elements to interact with blockchain, mainly for the realization of domain-specific smart contracts, such as Solidity.

Machine code: refers to the program code that can be directly processed by the computer, which is compiled and generated by the target language program, including program intermediate code, binary code, etc.

The invention completes the automatic and formalized conversion from legal contract to smart contract. It covers the conversion from traditional contract to the smart legal contract and the target language contract, as well as the whole process of smart contract deployment, signature, execution, and verification, as shown in FIG. 2. The functional modules of the system include:

1) The module of smart legal contract: it is used to formally represent the attributes and terms in natural language contracts, further generate the smart contracts according to the specified smart contract language;

2) The conversion module of target language contract: it is used to translate the smart legal contracts into executable target language contracts according to the conversion rules over target language. These conversion rules refer to a specified conversion mechanism which is used to realize time sequence control, default detection, party management and trigger mechanisms.

3) The module to deploy smart contract: it is used to compile each of target language contracts, further encapsulate these contracts as blockchain transactions which are issued into blockchain via consensus protocol. The deployment of the contracts is completed once the contracting parties sign the target language contracts;

4)The module of contract execution and verification: it is used to execute the functions of the target language contract by the blockchain nodes once the corresponding terms of the smart legal contract are triggered, further issue the execution results to blockchain in a blockchain transaction form after the execution termination. The transaction is stored into blockchain as an electronic certification of contract execution after the transaction contents are validated by the consensus protocol.

The method and system for executable smart legal contract construction and execution over legal contracts comprises the following parts: contract name (Title), contracting parties (Parties), assets' description (Assets), contract Terms (Terms) and additional information (Additional). The syntax is expressed as:

Contract::=Title{Parties+Assets+Terms+Additional+}.

where, + represents multiple items and the blank space is a separator.

The symbols and abbreviations in the smart legal contract language comprise the following:

? indicates that the front keyword is optional, which means it can be added or not according to needs;

{ } denotes a set containing several statements;

. represents a sentence terminator;

+ denotes multiple item selection which can be zero or multiple sentences;

[ ] represents a list in which statements may appear multiple times.

The contract name (Title) is used for describing basic information of the contract including a contract caption (Cname) and a contract address (Caddress) which is the storage location of this smart contract in blockchain. The syntax of contract name is expressed as follows:

Title::=contract Cname:[serial Caddress]

where, the contract and serial are keywords for representing the construction of the syntactic expression.

The contracting parties (Parties) is used for recording the name, address, and other description of party's property and characteristic (including constants and variables), as well as the behavior agreed in the contract. It includes the party name (Pname), the party's account address (Paddress), the party's attribute (field), the party's behavior (actions), where the party can be an individual or a group. The syntax represented as follows:

Parties::=party group?Pname:[address Paddress]{field+actions+}

where, party is a keyword indicating that this grammar is used to describe a party; group is an optional keyword that indicates the party is a group when it is added; and address is a keyword which indicates that the party's account address is immediately behind.

The assets' description (Assets) is the necessary condition for the established contract and the necessary terms of all contracts, which indicates the relation of right and obligation between the contracting parties. The assets' description contains the asset name (assetName), the assets' attribute (assetInfo), and the asset ownership (assetRight). The assets' attribute (assetInfo) contains the basic attribute information of this asset. The asset ownership (assetRight) contains the description of property rights between assets' owners and the assets, and associates the property rights with owners' account address. Assets' descriptions are generally divided into things, behaviors, and intellectual achievements, which syntax represented as follows:

Assets::=asset assetName:{assetInfo+assetRight+}

where, asset is a keyword which indicates that the grammar is used for assets' description.

The contract terms (Terms) is the digital representation of the contract conditions, which describes the process which refers to when or under what circumstances the contracting party shall or can perform certain behaviors and meet the requirements. It is the basis for determining the right and obligations of the contracting party. The contract terms (Terms) consist of the following parts: term name (tname), term party (pname), restricted execution behavior of party (action) which defines the party may (can), cannot (cannot) or must (shall) execute, the pre-condition of term execution (preCondition), asset transfer (transactions) in term execution process, and the post-condition (postCondition) which shall be satisfied after term execution. The syntax represented as follows:

Terms::= term tname: pname (shall|can|cannot) action

(when preCondition)?
(while transactions+)?
(where postCondition)?.

The pre-condition of term execution (preCondition) represents the pre-condition that shall be met to trigger and execute the term. The pre-conditions are checked before the party performs this action, and if the current environment meets the pre-condition (preCondition), the term will be triggered; The asset transfer (transactions) indicates the transfer of assets that accompany the execution of the terms; The post-condition (postCondition) indicates the state which shall be satisfied after term execution, if not, the operation will be rolled back to ensure the correct operation of this term.

The asset transfer (transactions) is used to represent different operation modes of assets during the contract execution, and multiple asset transfer sentences can be allowed in the same term. The asset transfer (transactions) includes three modes: deposit (deposit), withdrawal (withdraw), and transfer (transfer).

1) Deposit (deposit): It refers to that the party deposits assets into the contract account initiatively. It can be used directly to specify the description of the deposited assets or limit them according to the relationship as a part of the pre-condition of the term execution, and the syntax is expressed as follows:

Deposit::=deposit (value RelationOperator)?AssetExpression

where, AssetExpression represents the asset expression for describing the transferred asset; RelationOperator is a comparison relationship to specified asset expressions, including relationship values such as >, =, <, →, ←.

2) Withdrawal (withdraw): In the process of executing terms, the party will withdraw certain assets from the contract account according to this term, and the amount of assets is agreed in the contract by constants or variables in advance. The syntax is expressed as:

Withdraw::=withdraw AssetExpression

3) Transfer (transfer): In the process of executing terms, the party will transfer certain assets from the contract account to other parties according to this term, and the amount is also agreed in the contract by constants or variables in advance. The syntax is as follows:

Transfer::=transfer AssetExpression to Target

where, Target represents the target account of transfer process.

The additional information (Additional) gives the definition of other supplementary conditions required by the contract, including contract attributes, contract asset, party signature, guarantor information and signatures, additional terms, program variables and data structure definitions.

The conversion module of target language contract is a process that translate smart contracts written by smart legal contract language into target language contracts by using the conversion rules over target language. The types of specified target language contracts include party contract, main contract and asset contract, which are described in detail as follows:

1) The party contract is a target language contract generated according to the content related to the contracting parties (Parties) in the smart legal contract, which is responsible for the management of parties, recording and counting of events, querying record and so on. The party contract includes three parts which are party's attributes (field), party management and the management of term execution.

2) The main contract includes variable definition, modifier and function framework generated by each term and is mainly divided into two parts. The first one is the generation of contract attributes, definition and initialization of parties; the other one is the conversion of terms. The latter mainly executes language conversion according to contract terms (Terms) in the smart legal contract while each term corresponds to a function. The function includes condition detection, main body of function and detection of execution result, which respectively correspond to pre-condition (preCondition) of term execution, asset transfer (transactions) and post-condition (postCondition) of contract terms (Terms) in the smart legal contract language. Meanwhile, the corresponding default detection mechanism is set in each detection.

3) The asset contract refers to a target language contract that is generated by each asset (Assets) in the smart legal contract, which consists of the following parts: the asset property structure which is obtained by mapping the assets' attributes (assetlnfo) and the asset ownership (assetRight), and is used as the basic data structure for other functions; the asset management method which relates to registering, inquiry, transfer, etc., and can be self-defined according to contract requirements; the management method of asset ownership (assetRight) which relates to property acquisition, property setup and property transfer methods.

The conversion rules of target language are conversion rules required to convert a smart legal contract into a target language contract, which comprises the following parts:

1) Realizing the conversion from contracting party (Parties) in the smart legal contract to party contract. According to whether the keyword “group” exists or not, there are two conversion rules, namely individual party contracts (IPC) and group party contracts (GPC);

2) Realizing the conversion from contract name (Title), each contract term (Terms) and additional information (Additional) in the smart legal contract to main contract;

3) Realizing the conversion from assets' description (Assets) to asset contract in the smart legal contract.

The conversion rule of the individual party contract (IPC) refers to the method for converting the description of the individual party in the smart legal contract into the individual party contract (IPC). It comprises the following steps:

1) Add a contract structure: Add a new contract structure taking party name (Pname) in the smart legal contract as the contract name, wherein the contract framework is a collection of program codes comprising structure, library, class, interface, and package. The sentences obtained in the subsequent processes will be put into it.

2) Store the properties of individual party: Individual party's properties include party's account address (Paddress), party's attributes (field) and record functions of term execution, wherein the account address (Paddress) is the unique identification of account; the individual party's attributes in the target language contract are generated from the party's attributes (field) of the same names in this smart legal contract, and the “setting” and “getting” methods are added to write and read the corresponding property values, respectively; for each of the contract terms (Terms), a record function of term execution is added to mark whether the execution of this term has been completed by the party's behavior (action), and store the executed time of this term.

3) Implement individual party management methods: Add the functions of registering, deregistering and querying the party on the basis of the account address (Paddress) in the previous step, which can be used for adding, deleting, and querying the party information in the blockchain corresponding to personnel account.

4) Implement individual term execution methods: Add the recording function for each term in smart legal contract to record the completion time when the term execution is finished, and add a status query function to return the term completion time.

The conversion rule of the group principal contract (GPC) is a method for converting the contracting party followed by “group” keyword into the group principal contract. It comprises the following steps:

1) Add a contract structure: Add a new contract structure taking the party name (Pname) in the smart legal contract as the contract name wherein the sentences obtained in the subsequent processes will be added into it.

2) Store group party's properties: Store each individual party's information of the group into a structure array. Each unit of this structure array is set according to step 2) of the conversion rule of the individual party contract (IPC). Add a mapping table from each party's account address (Paddress) to the coordinate of the array unit corresponding to the party in order to fix the position of each party in the group.

3) Implement group party management methods: The methods for realizing group party management ensure that randomly accessing account addresses and traversal of individual parties can be quickly realized by combining arrays and mappings, and comprises the following steps: add adding, deleting, modifying and querying functions of each individual parties' account addresses (Paddress) in the group, wherein the querying functions comprise inquiring for the total number of parties in the group, whether a certain party belongs to the group, and the list of all individuals in the group.

4) Implement group term execution management methods: Add the term execution management methods for terms corresponding to the individual in the group according to step 4) in the conversion rule of the individual party (IPC) to record the time at which each individual party of this group has completed term. Moreover, two record functions of term execution are added to record the time at which the first and the last individual parties have completed term, and a query function is added to obtain the time at which the first, the last and the current individual parties have completed terms.

The conversion rule of main contract refers to generating the main body of the target language contract and the execution codes corresponding to each term in the smart legal contract. It comprises the following steps:

1) Add a contract structure: Add a new contract structure, and set its name as the contract caption (Cname) of the smart legal contract. Then, carry out instantiation and initialization of asset contracts and the party contracts that includes the group party contract and the individual party contract, and put the sentences obtained in the subsequent processing steps into the contract.

2) Conversion of the Additional information: add and initialize the variables, corresponding to the defined values in the additional information (Additional) of the smart legal contract, into the contract.

3) Conversion of contract terms: Convert the contract terms (Terms) of the smart legal contract into the functions with the same action name one by one, and its specific steps are as follows. Generate the functions with the same action names according to the term names (tname) which consist of testing sentences of pre-conditions of term execution, sentences to execute term, and testing sentences of execution results. a) Translate the expressions of deposit (deposit) in the asset transfer (transactions) and the pre-conditions of term execution (preCondition) into the testing sentences of pre-conditions. b) Translate the expressions of withdrawal (withdraw) or transfer (transfer) in the asset transfer (transactions) into the sentences to execute term. c) Translate the post-condition (postCondition) into the sentences to execute term or the testing sentences of execution results.

The conversion of asset contract refers to the generation of asset contracts containing the asset property structure and the asset management methods for each asset in smart legal contract, which comprises the following steps:

1) Add a contract structure: Add a new contract structure, namely asset property structure, whose name is the same as the corresponding asset name (assetName) in the smart legal contract, and the sentences obtained in the subsequent processing steps of the asset will be put into this contract.

2) Construct the asset attribute structure: generate an asset property structure with the same name as the corresponding asset name (assetName) in the target language contract. Then, all of variables with the same name as the assets' attributes (assetlnfo), as well as the asset ownership (assetRight) in assets' description (Assets) are added into the contract.

3) Implement asset management methods: add executable codes used to perform asset transfer (transactions) into the asset contract, where the categories of asset transfer (transactions) contain deposit (deposit), withdrawal (withdraw) and transfer (transfer). Moreover, query functions for these variables are also constructed.

The conversion module of the target language contract has a security mechanism with smart legal contract, which includes:
1) Sequential control: It refers to the process of controlling the execution of a contract through the automatic recording of key events, in accordance with chronological order or time limitation of events stated by contract terms. According to the time expressions, logical expressions, relational expressions, arithmetic expressions, and constant expressions contained in the pre-conditions (preCondition) of contract terms (Terms), timing attributes and comparison expressions on them are generated in the target language contract as conditions for the detection of the chronological order, occurrence and termination time of events in the contract terms.

2) Trigger mechanism: Once the execution of smart contracts is completed, the running state is saved in the blockchain, and the program goes into hibernation state until it is triggered by an external event or other contract to wake up the contract to perform one of its functions. This mechanism is implemented by interrupt handling and event response in existing blockchain and smart contract platforms.

3) Breach detection: It is the process by which smart contracts detect the behaviors of parties that violate contract terms or current regulations. The mechanism detects the program state by the conventions of post-condition (postCondition) which shall be satisfied after term execution.

4) Party management: It refers to the management of the identity, attributes, and terms execution conditions of the party according to the types of parties in the party contract. If the party represents an individual, it provides the functions of registering and deregistering of this party and the “setting” and “getting” methods to write and read the corresponding property values and term execution conditions; if the party represents a group, it provides the functions of adding, deleting, modifying and querying individual parties' properties in this group on the basis of the account address. Then, it will provide functions of recording term execution conditions, as well as three query functions obtain the times at which the first, the last and the current individual parties have completed terms in this group.

The module to deploy smart contract refers to the process for deploying the converted target language contract on the blockchain, and consists of the following steps:

1) Compilation of target language contract: The target language contract is converted into machine codes, which are running in a virtual machine or container, by a language compiler of the existing blockchain and smart contract platform. The machine codes are Turing-complete for responding the triggered events and predefining interactive operations on blockchain;

2) Deployment of smart contract: All of the specified machine codes, the target language contracts and the contract execution states are encapsulated in a blockchain transaction form, further issued into blockchain as the electronic certification of the original smart legal contract, in such a way that the blockchain nodes can obtain them and implement the signing, executing and verifying of the smart legal contract.

The transaction publishing refers to the process that after the transaction is issued into the blockchain, it is broadcast to all nodes in the blockchain network, and is added into the blockchain storage via the correctness verification by the consensus mechanism. Wherein, the consensus mechanism is a mechanism that the blockchain node achieves the whole network agreement on the block information (including transactions), and the consensus mechanism comprises: Proof of Work, Proof of Stake, a mix of Proof of Work and Proof of Stake, Proof of Authority, Byzantine Fault Tolerance, etc.

The contract signing methods are divided into a static way of pre-defined party list and a dynamic way of joining party in runtime, and these ways can be mixed use. The use in this invention is shown in FIG. 4. The static way refers that the pre-defined party list, indicating who would sign the contract, has already been made. The dynamic way refers that the users don't specify the pre-defined party list, and they can add the party list indicating who should sign in the execution process of contract.

The static way of pre-defined party list consists of the following modules:

1) Interface of pre-defined party list: this interface given in smart legal contract is used to indicate the pre-defined party list of who should sign the contract according to the user's needs during contract formulation. This list includes the pre-defined parties' account addresses (Paddress) and the blank signatures of these parties to be filled.

2) Signature interface of pre-defined party: After the contract is deployed on blockchain, the parties in the corresponding list can sign the contract according to their account address (Paddress).

3) Signature storage interface: The signer's signature will be verified by comparing their account addresses (Paddres) and the ones in the pre-defined party list. If the verification result is correct, the signature content is added and stored permanently in the blockchain, and all nodes can check and verify whether the party has the right to sign, whether the signature has been signed and whether the signature is correct.

The dynamic way of joining party in runtime consists of the following modules:

1) Interface for applying to signing: The parties who intend to join the contract can sign the contract according to their account addresses. Then, the parties' account addresses and signatures will be packaged and issued for signature application.

2) Signature permission interface: According to the contract terms, the parties who apply for joining the contract would be examined to determine whether they can join the party signature list of the contract. The interface can also be set as permanent permission, deadline permission and operation permission.

3) Signature storage interface: This interface is identical to the third interface of the static way.

The module of contract execution and verification refers to the process for automatically executing contract terms once they are triggered by an external event or an internal contract, and this module consists of the following steps:

1) Executing the smart contract: Before executing or verifying a smart contract, the smart contract code is downloaded, the contract state stored in the blockchain is restored simultaneously to the memory, and the required contract terms are called and executed according to the input parameters in the local virtual machine;

2) Issuing the execution result: The execution results of the smart contract are issued to the blockchain in a transaction form after the execution termination. The transaction is stored into blockchain as a legally-recognized electronic certification of contract execution after the transaction contents are validated by other blockchain nodes through the consensus protocol.

The consensus verification of the content contained in the transaction refers to the verification process of the other nodes in blockchain to the transaction containing the smart contract execution result through the consensus mechanism, and the verification process includes the compliance and legitimacy of transaction format, party identity, contract execution process, intermediate state, contract execution result, time stamp, etc.

The legally-recognized electronic certification form makes the following requirements for the above-mentioned transactions. 1) Using digital signature technology to mark the parties concerned in each transaction; 2) The marked transaction is calculated with the cryptographic hash function in the blockchain to generate their respective hash values; 3) The hash values of multiple transactions are grouped successively in pairs and then hashed to form the Merkel-tree structure and stored in the block; 4) Each block is interconnected with each other in the form of a hash chain. After these steps, the above-mentioned transactions are stored in the form of electronic data that meets current legal requirements and cannot be tampered with, which is also called electronic certificate.

The invention has the following positive effects:

1) Starting from the analysis of traditional contracts, the invention proposes a concise, expressive, and more complete formal expression mechanism of contract language, including the digital representation of assets, property relations, logical expression of contract terms, etc., which breaks the domain barrier between smart contracts and non-programmers, and can better meet the requirements of automated and formal transformation of legal contracts.

2) The invention provides a set of effective expression methods and operating mechanisms for contracts, and the contract expression form is easy to read and learn, rich in expression content, comprehensive in expression ability, and correct in expression logic, which can play a large role in promoting the normalization and standardization of smart contract development.

3) The invention proposes the method and system for executable smart legal contract construction and execution over legal contracts, which implements the whole procedure of converting a traditional contract into smart contracts and their deployment and execution, as well as the design of trigger conditions and signature mechanisms between terms. The invention lays a foundation for the research on the validity and compliance of electronic contracts, and the standardization of smart contract system construction.

### BRIEF DESCRIPTION OF THE DRAWINGS

FIG. 1 is a schematic diagram illustrating the execution process of blockchain smart contract in the invention;

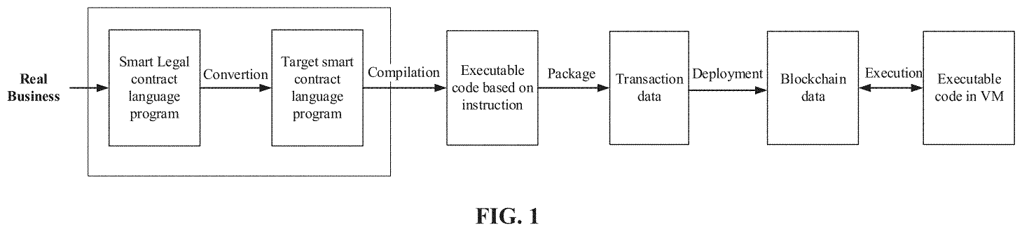

FIG. 2 is a module diagram of the smart contract system in the invention;

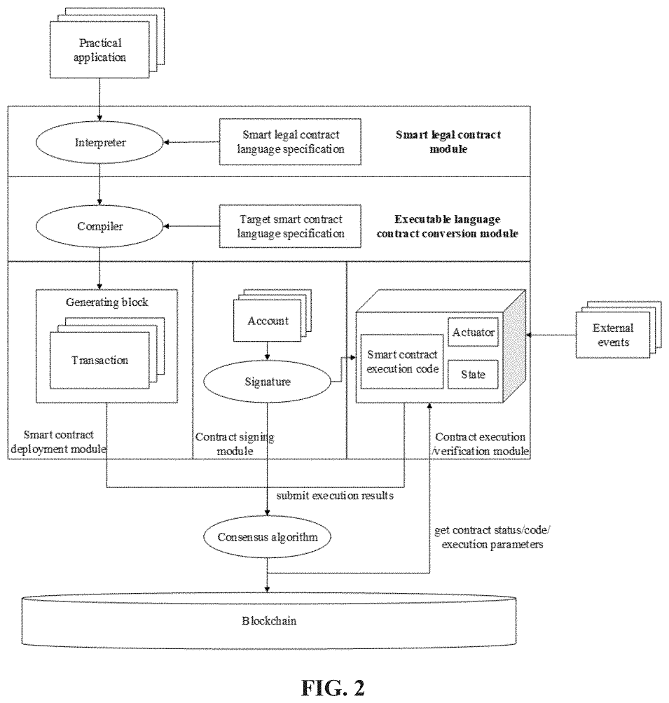

FIG. 3 is a schematic diagram illustrating the abstract model of blockchain smart contract in the invention;

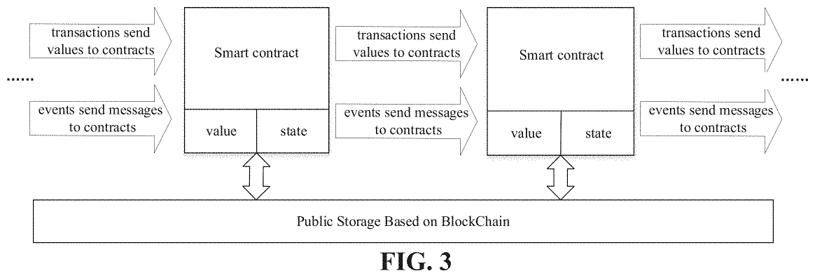

FIG. 4 is a schematic diagram illustrating the signature process in the invention;

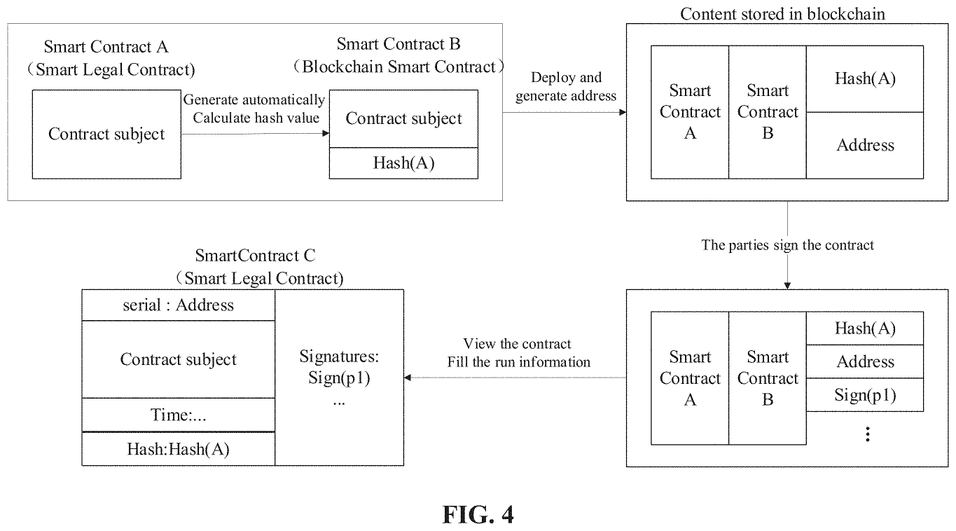

FIG. 5 is a framework diagram illustrating the smart contract implemented by taking a purchase contract as an example in accordance with the embodiment of the invention.

### DETAILED DESCRIPTION OF EXEMPLARY EMBODIMENTS

In order to make the technical problems, technical solutions, and advantages to be solved by the present invention clearer, the following description will be given in detail with reference to embodiments.

In the embodiment, a simple specific contract is taken as an example to demonstrate the actual running process of the method and system for executable smart legal contract construction and execution over legal contracts, which includes: write an smart legal contract from a traditional contract→target language contract→contract deployment→contract signature→contract operation.

### Embodiment 1

In this embodiment, a traditional contract content is defined as follows: the buyer and the seller of contract parties perform a purchase transaction on one printer. The specific contract contents will be introduced one by one later and the corresponding smart legal language contract will be implemented.

Firstly, write the contract in smart legal contract language.
1) Contracting parties: including buyers and sellers.

The seller has an account address (Paddress) as the unique identification, and can perform the actions of collecting transaction's payment and delivering the printers, which are defined as follows:

party Seller: address 0x14723A09ACff6D2A60DcdF7aA4AFf308FDDC160C {

credentials: String
deliever( )
collectPayment ( )

}

The buyer is a group party, and can perform the actions of ordering printers and confirming receipt of printers, which is defined as follows:

party group Buyer{

order( )
confirmReceive( )

}

2) Assets' description: a machine named printer, worth 2000 CNY, has its own unique identification. Its definition is as follows:

asset Printer: address 0xCA35b7d915458EF540aDe6068dFe2F44E8fa733c {

name: “Printer”
value: 2000 RMB

}

3) Definition of contract terms:

(1) Term 1: the buyer can order a printer from the seller while deposits the printer's value into the contract.

term no1: Buyer can order

while deposit $ Printer::value.

(2) Term 2: if the buyer orders a printer from the seller, the contract will be validated and the seller should send the printer to the buyer within 7 days.

term no2: Seller shall deliver

when within 7 days after Buyer did order.

(3) Term 3: the buyer should confirm the receipt of this printer within 7 days.

term no3: Buyer shall confirmReceive

when within 7 days after Buyer did receive.

(4) Term 4: after the buyer confirming the receipt, the seller can collect the payment and close the transaction.

term no4: Seller can CollectPayment

when after Buyer did confirmReceive
while withdraw $ Printer::value.

4) The additional information (Additional) of the contract, which adds signatures of both parties.

SellerSignature : String
BuyerSignature : String

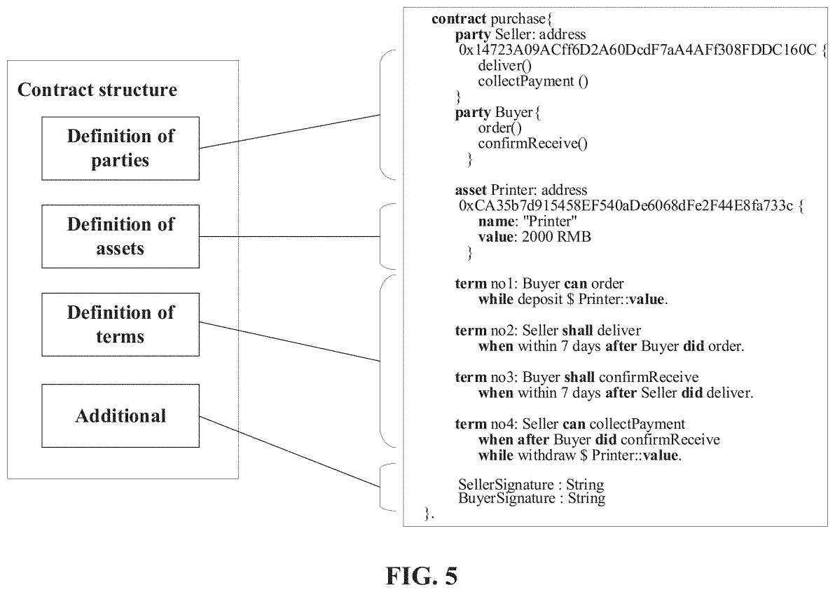

5) The complete contract is as follows, and its frame diagram is shown in FIG. 5:

contract purchase{

party Seller: address 0x14723A09ACff6D2A60DcdF7aA4AFf308FDDC160C {

deliver( )
collectPayment ( )

}
party group Buyer{

order( )
confirmReceive( )

}
asset Printer: address 0xCA35b7d915458EF540aDe6068dFe2F44E8fa733c {

name: “Printer”
value: 2000 RMB

}
SellerSignature : String
BuyerSignature : String
term no1: Buyer can order

while deposit $ Printer::value.

term no2: Seller shall deliver

when within 7 days after Buyer did order.

term no3: Buyer shall confirmReceive

when within 7 days after Seller did deliver.

term no4: Seller can collectPayment

when after Buyer did confirmReceive
while withdraw $ Printer::value.

}.

Secondly, convert the smart legal contract to the target language contract.

In this embodiment, solidity is selected as the target language to complete the conversion from the instance implemented by the smart legal contract to the target language, forming the target language contract.
1. Two party contracts are generated from the contracting parties (Seller, Buyer):
1) The seller is an individual party, and the conversion rule of the IPC is adopted:

party Seller: address 0x14723A09ACff6D2A60DcdF7aA4AFf308FDDC160C {

credentials: String
deliver( )
collectPayment ( )

}

\textcircled{1} Create a party contract structure named SellerT: contact SellerT{ }, and the subsequent conversion of Seller will be put in { }.
\textcircled{2} Store individual party's properties:

Add the _Selleraddress to record the seller's account address. The Seller's other properties include the credentials of String type, so a variable is created: bytes32 credentials, and its “setting” and “getting” functions are added:

function getcredentials( ) returns(bytes32 _result){ return credentials; }
function setcredentials( bytes32 a){ credentials = a; }

Generate term execution functions according to the terms: term no2 and term no4 corresponding to drivers( ) and collectPayment( ) contained in the Seller, that is, creating variables for whether the corresponding term are started or finished.

//attributes of action deliver
bool _isdeliverDone;
uint _deliverTime;
//attributes of action collectPayment
bool _iscollectPaymentDone;
uint _collectPaymentTime;

\textcircled{3} Implement individual party management methods, which only involves the functions of registering, deregistering and querying for the Seller in this embodiment:

function regist(address a) public {

SellerAddress = a;

}
function getAddress( ) public returns (address a){

return_SellerAddress;

}

\textcircled{4} Implement individual term execution methods, which generate a record function of term execution to record completion time and a status query function to return the term completion time. Take deliver here as an example, collectPayment is the same:

function deliverDone( ){

_deliverTime = now;
_isdeliverDone = true;

}
function deliverTime( ) returns (uint result){

if(_isdeliverDone){

return _deliverTime;

}
return _max;

}

2) The buyer is a group party, and adopts the conversion rule of group party contract (GPC):

party group Buyer{

order( )
confirmReceive( )

}

\textcircled{1} Add a contract structure named BuyerT: contract BuyerT{ }, and the subsequent conversion of Buyer will be put in { }.
\textcircled{2} Store group party's properties:

Establish a structure array named Buyertype, in which each property value is constructed according to individual party contract (IPC) rules as follows:

Buyertype[ ] _BuyerEntity;
struct Buyertype{

address _Buyeraddress;
//attributes of action order
bool _isorderDone;
uint _orderTime;
//attributes of action confirmReceive
bool _isconfirmReceiveDone;
uint _confirmReceiveTime;

}

Add a mapping table from the account address (Paddress) to the array's coordinate as follows:

mapping(address→uint) _userlist;
\textcircled{3} Implement group party management methods, adding a series of functions as follows:

The “Create” function:

function add(address a) public {

_BuyerEntity.push(_Empty);
_userlist[a] = _sum;
_sum ++;

}

The “Delete” function:

function remove(address a) public {
uint num = _userlist[a];
_BuyerEntity[num] = _BuyerEntity[_sum−1];
_userlist[_BuyerEntity[num]._Buyeraddress] = num;
delete(_BuyerEntity[num]);
delete(_userlist[a]);
_sum −−;
}

Query function of “list of all individuals in the group”:

function getList( ) public returns (address[ ]){

address[ ] a;
for(uint i = 0; i < _sum; i ++)

a[i] = _BuyerEntity[i]._Buyeraddress;

return a;

}

Query function of “whether a certain party belongs to the group”:

function contains(address a) public returns (bool b){

return _userlist[a] != 0;

}

Query function of “total number of parties in the group”:

function getSum( ) public returns(uint c){

return _sum;

}

\textcircled{4} Implement group term execution management methods. For one thing, add the term execution management methods for each term corresponding to the individual in the group according to step ® of the conversion rule of individual party contract (IPC), that is, generate term execution functions according to the terms: term no1 and term no3 corresponding to order( ) and confirmReceive( ) contained in the Buyer, wherein the confirmReceive( ) is taken as an example:

function confirmReceiveDone(address a){

uint num = _userlist[a];
_BuyerEntity[num]._confirmReceiveTime = now;
_BuyerEntity[num]._isconfirmReceiveDone = true;
_confirmReceiveTime.push(_BuyerEntity
[num]._confirmReceiveTime);
_confirmReceiveDoneNum ++;

}
function confirmReceiveTime(address a) returns (uint result){

uint num = _userlist[a];
if(_BuyerEntity[num]._isconfirmReceiveDone){

return _BuyerEntity[num]._confirmReceiveTime;

}
return _max;

}

For another, add the record function of term execution to record the time at which each individual party has completed term, and mark the time at which the first and the last individual parties have completed term. Then, generate a query function to obtain the time at which the first, the last and the current individual parties have completed terms. Take the order( ) as the example, and comfirmReceive( ) is the same.

function orderTime(address a) returns (uint result){

uint num = _userlist[a];
if(_BuyerEntity[num]._isorderDone){

return _BuyerEntity[num]._orderTime;

}
return _max;

}
function orderAllTime( ) returns (uint result){

if(_orderDoneNum == _max−1){

return _orderTime[_orderDoneNum−1];

}
return _max;

}
function orderSomeTime( ) returns (uint result){

if(_orderDoneNum >= 1){

return _orderTime[0];

}
return _max;

}

2. Convert the smart legal contract into a main contract.
1) Add an asset property structure named Purchase: contract Purchase{ }, carry out the instantiation and initialization of party contracts, and the modules generated by subsequent conversions are put in { }.

import “./SellerT.sol”;
import “./BuyerT.sol”;
contract SimplePurchasetry {

SellerT Seller;
BuyerT Buyer;
function SimplePurchasetry( ){

start = now;
Seller = new SellerT( );
Buyer = new BuyerT( );

}

}

2) Convert the additional information: convert the definition contained in the additional information (Additional) in the smart legal contract:

bytes32 SellerSignature;
bytes32 BuyerSignature;

3) Convert contract terms: convert contract terms (Terms) in the smart legal contract one by one.

\textcircled{1} term no1: Buyer can order

while deposit $ Printer::value.

This term includes the expression of deposit (deposit) in the asset transfer (transactions), so the testing sentences of pre-condition: require(msg.value←printer.value) is generated. Then the final formed function is:

function order( ) onlyBuyer( ) public payable {

require(msg.value >= printer.value);
Buyer. order Done( );

}

\textcircled{2} term no2: Seller shall deliver

when within 7 days after Buyer did order.

The term includes a pre-condition (preCondition), according to which a testing sentences of pre-condition for time is generated, and the formed function is:

function deliver( ) onlySeller( ) public {

require((now > Buyer.orderTime(msg.sender))

&&(now < Buyer.orderTime(msg.sender)+604800));

Seller. deliverDone( );

}

\textcircled{3} term no3: Buyer shall confirmReceive

when within 7 days after Seller did deliver.

The term includes a pre-condition (preCondition), according to which a testing sentences of pre-condition for time is generated, and the formed function is:

function confirmReceive( ) onlyBuyer( ) public {

require((now > Seller.deliverTime( ))

&&(now < Seller.deliverTime( ) + 604800));

Buyer. confirmReceiveDone( );

}

\textcircled{4} term no4: Seller can colletPayment

when after Buyer did confirmReceive
while withdraw $ Printer::value.

The term includes a pre-condition (preCondition), from which a testing sentences of pre-condition for time is generated: require (now>Buyer. confirmReceivetime(msg.sender)). The line after while indicates it is the expression of withdrawal (withdraw) in the asset transfer (transactions), so the sentences to execute term is generated: msg.sender.transfer(Printer.value), and the final formed function is:

function collectPayment( ) onlySeller( ) public payable {

require(now > Buyer.confirmReceiveTime(msg.sender))
Buyer.getAddress.transfer(Printer. value);
Seller.ColletPaymentDone( );

}

4) The final main contract is:

pragma solidity > =0.4.0 < 0.6.0;
import “./SellerT.sol”;
import “./BuyerT.sol”;
import “./Printer.sol”; // The asset contracts, which will be introduced later.
contract SimplePurchasetry {

SellerT Seller;
BuyerT Buyer;
Printer printer;
bytes32 SellerSignature;
bytes32 BuyerSignature;
uint start;
function SimplePurchasetry( ){

start = now;
Seller = new SellerT( );
Buyer = new BuyerT( );

}

modifier onlySeller{ require(Seller.contains(msg.sender)); }
modifier onlyBuyer{ require(Buyer.contains(msg.sender)); }
function order( ) onlyBuyer( ) public payable {

require(msg.value >= printer.value);
Buyer. order Done( );

}
function deliver( ) onlySeller( ) public {

require((now > Buyer.orderTime(msg.sender))

&&(now < Buyer.orderTime(msg.sender)+604800));

Seller. deliverDone( );

}
function confirmReceive( ) onlyBuyer( ) public {

require((now > Seller.deliverTime( )) &&(now < Seller.deliverTime( )+604800));
Buyer. confirmReceiveDone( );

}
function collectPayment( ) onlySeller( ) public payable {

require(now > Buyer.confirmReceiveTime(msg.sender))
Buyer.getAddress.transfer(Printer. value);
Seller.ColletPaymentDone( );

}

}

3. Convert the smart legal contract into an asset contract.

asset Printer: address 0xCA35b7d915458EF540aDe6068dFe2F44E8fa733c {

info{

name: “Printer”
value: 2000 RMB

}

}.

1) Add a contract structure, named PrinterT: contract PrinterT{ }, and the subsequent conversion will be put in { }.
2) Construct the asset property structure: generate a structure body named Printer, and add the corresponding variables according to the attributes (assetInfo) of the Printer;

struct Printer{

bytes32 name;
uint value;

}

3) Implement asset management methods: The asset is instantiated and initialized based on above attributes and query functions are constructed for the attributes;

Printer _ printer;
printer.Name=”Printer”;
printer.value =”2000”;
function getname( ) returns(bytes32 _result){

return name;

}
function getvalue ( ) returns(uint _result){

return value;

}

Thirdly, deploy target language contract.

The target language contract and its initial trigger state are issued to the blockchain. The contract address (Caddress) of the contracts will be returned, through which the parties can invoke or check the contract. In this embodiment, the seller issues the contract of selling printer to the blockchain and signs the contract unilaterally (<addressSeller, signatureSeller>) without restricting the pre-defined party list of the buyer in advance. Therefore, the buyer can dynamically join the contract through signature application interface.

The blockchain transaction code is as follows:

a {

“accounts”: {

“account{0}”: “0xCA35b7d915458EF540aDe6068dFe2F44E8fa733c”

},
“linkReferences”: { },
“transactions”: [

{

“timestamp”: 1584190910265,
“record”: {

“value”: “0”,
“parameters”: [ ],
“abi”:

“0xc41589e7559804ea4a2080dad19d876a024ccb05117835447d72ce08c1d020ec”,

“contractName”: “Purchase”,
“bytecode”:

“608060405234801561001057600080fd5b5060405161001d906101a4565b604051809103906
000f080158015610039573d6000803e.............”,

“linkReferences”: { },
“name”: “”,
“inputs”: “( )”,
“type”: “constructor”,
“from”: “account{0}”

}

}

],
“abis”: {

“0xc41589e7559804ea4a2080dadl9d876a024ccb05117835447d72ce08c1d020ec”: [

{

“constant”: false,
“inputs”: [ ],
“name”: “CollectPayment”,
“outputs”: [ ],
“payable”: true,
“stateMutability”: “payable”,
“type”: “function”

},
{

“constant”: false,
“inputs”: [ ],
“name”: “confirmReceive”,
“outputs”: [ ],
“payable”: false,
“stateMutability”: “nonpayable”,
“type”: “function”

},
{

“constant”: false,
“inputs”: [ ],
“name”: “deliver”,
“outputs”: [ ],
“payable”: false,
“stateMutability”: “nonpayable”,
“type”: “function”

},
{

“constant”: false,
“inputs”: [ ],
“name”: “order”,
“outputs”: [ ],
“payable”: true,
“stateMutability”: “payable”,
“type”: “function”

},
{

“inputs”: [ ],
“payable”: false,
“stateMutability”: “nonpayable”,
“type”: “constructor”

}

]

}

}.

Fourthly, execute the module of contract execution and verification.

1) When a buyer intends to order the printer, he/she can trigger the function interface order( ) while transfer the price of printer to contract account as the subscription, and sign the contract through the interface for applying to signing (<addressBuyer, signatureBuyer>). At this point, both buyer and seller have signed the list, the contract becomes effective and the order is successful.

2) After the contract becomes effective, the seller is triggered to perform the deliver action in a specific limited time period.

3) After the buyer receives the printer, the interface confirmReceive( ) needs to be called to confirm and record a receipt of the printer.

4) After the buyer calls the confirmReceive( ), the seller can collect payments while taking out 2000 RMB from the contract account, then the execution of contract is completed.

5) In the above steps, if any contract state of them is inconsistent with the post-condition (postCondition) of contract terms, it will enter the breach-state of contract and trigger the handling mechanism.

While the foregoing is the preferred embodiment of the invention, it will be appreciated that various changes and modifications can be made by those skilled in the art without departing from the spirit and scope of the invention, which also is regarded as the protection scope of the invention.

What is claimed is:

1. A method of executable smart legal contract construction and execution over legal contracts, including:
1) use the specified smart contract language to formally represent attributes and terms in natural language contracts, further generate smart contracts;
2) use the conversion rules over target language to translate the smart legal contracts into executable target language contracts; the types of specified target language contracts include party contract, main contract and asset contract, where the party contract is generated from the contracting parties (Parties), the asset contract is from the assets' description (Assets), and the expressions of contract terms (Terms) and additional information (Additional) are translated into main contract in terms of grammar in the target language;
3) each of target language contracts is compiled, further encapsulated as a blockchain transaction which is issued into blockchain via consensus protocol; the deployment of the contracts is completed once the contracting parties sign the target language contracts;
4) once term of the smart legal contract is triggered, the corresponding functions of the target language contract will be executed by the blockchain nodes, and the execution results are issued to blockchain in a blockchain transaction form after the execution termination; the transaction is stored into blockchain as an electronic certification of contract execution after the transaction contents are validated by the consensus protocol.

2. The method of claim 1, wherein the specified smart contract language is a smart legal contract language and the smart contract is a smart legal contract; and the linguistic elements of smart legal contract language include: contract name (Title), contracting parties (Parties), assets' description (Assets), contract terms (Terms) and additional information (Additional).

3. The method of claim 2, wherein
the contract name (Title) includes contract caption (Cname) and contract address (Caddress), where the contract address (Caddress) is the storage location of this smart contract in blockchain;
the contracting parties (Parties) include the descriptions of party name (Pname), party's account address (Paddress), party's attributes (field) and party's behaviors (actions);
the assets' description (Assets) includes asset name (assetName), asset's attribute (assetlnfo) and the asset ownership (assetRight), where asset's attribute (assetlnfo) includes the basic information of assets, the asset ownership (assetRight) contains the description of property rights between assets' owners and the assets, and associates the property rights with owners' account address;
the specified contract terms (Terms) include the description of term name (tname), term party (pname), restricted execution behavior of party (action), the pre-condition of term execution (preCondition), asset transfer (transactions) in term execution process, and the post-condition (postCondition) which shall be satisfied after term execution.

4. The method of claim 1, wherein the specified party contract is divided into individual party contract (IPC) and group party contract (GPC), where:
the conversion rule to generate individual party contract (IPC): when the contracting party is an individual, the properties of the individual party are extracted from this smart legal contract, including party's account address (Paddress), party's attributes (field) and record functions of term execution; in this process, the account address is the unique identification of account, and the functions of registering, deregistering and querying the party are added into the contract on the basis of the account address; the individual party's properties in the target language contract are generated from the party's attributes (field) of the same names in this smart legal contract, and the “setting” and “getting” methods are added to write and read the corresponding property values, respectively; for each of the contract terms (Terms), a record function of term execution is added to mark whether the execution of this term has been completed by the party's behavior (action), and store the executed time of this term;
the conversion rule to generate group party contract (GPC): when the contracting parties are a group, the properties of each party in the group are extracted from this smart legal contract, including parties' account address (Paddress), parties' attributes (field) and record functions of term execution; moreover, these properties are stored into an array of structures, in which each of units is used to record the properties of an individual party in this group; then, the mapping table, which maps party's account address into the coordinate of the array unit corresponding to the party, is added into the contract; furthermore, the functions of adding, deleting, modifying and querying individual party in this group are added on the basis of the account address of the party in the array, and the functions of registering, deregistering and querying individual party are added according to party's account address; and finally, for each of the contract terms (Terms), the functions of term execution are added to record the time at which each individual party of this group have completed term, according to the same method of generating the individual party contract (IPC); moreover, two record functions of term execution are added to record the time at which the first and the last individual parties have completed term, and query functions are added to obtain the time at which the first, the last and the current individual parties in the group have completed terms.

5. The method of claim 3, wherein the specified pre-condition of executed term (preCondition) includes the expressions of time, logic, relationship, operation and constant; in the Step 2), the specified condition of term execution (preCondition) is translated into the target language codes to control event sequence, which refers to chronological order or time limitation of events stated by contract terms, for restricting the execution process of the converted target language contract.

6. The method of claim 1, wherein
the conversion rule to generate asset contract: for a given asset, an asset property structure, whose name is the same as the corresponding asset name (assetName) in the smart legal contract, is generated in the contract, namely the specified asset attribute structure; then, all of variables with the same name as the assets' attributes (assetlnfo), as well as the asset ownership (assetRight), in assets' description (Assets) are added into the contract; a query function for these variables is also constructed; moreover, the executable codes used to perform asset transfer (transactions) are added into the contract, where the categories of asset transfer (transactions) contain deposit (deposit), withdrawal (withdraw) and transfer (transfer);
the conversion rule to generate main contract: firstly, set the name of the contract as the contract caption (Cname) of the smart legal contract, further create instances of either party or asset contracts and set them to their initial values; then, the variables, corresponding to the defined values in the additional information (Additional) of the smart legal contract, are added and initialized in the contract; finally, each of contract terms (Terms) in the smart legal contract is converted into the functions with the same action names in the target language, and these functions are added into the main contract.

7. The method of claim 6, wherein the specified functions with the same action names include testing sentences of pre-conditions of term execution, sentences to execute term, and testing sentences of execution results, including a) translate the expressions of deposit (deposit) in the asset transfer (transactions) and the pre-conditions of term execution (preCondition) into the testing sentences of pre-conditions; b) translate the expressions of withdrawal (withdraw) or transfer (transfer) in the asset transfer (transactions) into the sentences to execute term; and c) translate the post-condition (postCondition) into the sentences to execute term or the testing sentences of execution results.

8. The method of claim 1, wherein the conversion rules over target language support security mechanism, including sequential control, trigger mechanism, breach detection and party management; the language compiler shall be used to compile the target language contracts to machine codes run in virtual machine or container; the machine codes are Turing-complete for responding the triggered events and predefining interactive operations on blockchain; and all of the specified machine codes, the target language contracts and the contract execution states are encapsulated in a blockchain transaction form, further issued into blockchain as the electronic certification of the original smart legal contract, in such a way that the blockchain nodes can obtain them and implement the signing, executing and verifying of the smart legal contract.

9. The method of claim 8, wherein the contracting parties can implement the signing of the smart legal contract by using a static way of pre-defined party list or a dynamic way of joining party in runtime.

10. A system of executable smart legal contract construction and execution over legal contracts, including the module of smart legal contract, the conversion module of target language contract, the module to deploy smart contract, and the module of contract execution and verification, where:
the module of smart legal contract is used to formally represent the attributes and terms in natural language contracts, further generate the smart contracts according to the specified smart contract language;
the conversion module of target language contract is used to translate the smart legal contracts into executable target language contracts according to the conversion rules over target language; the types of specified target language contracts include party contract, main contract and asset contract, where the party contract is generated from the contracting parties (Parties), the asset contract is from the assets' description (Assets), and the expressions of contract terms (Terms) and additional information (Additional) are translated into main contract in terms of grammar in the target language;
the module to deploy smart contract is used to compile each of target language contracts, further encapsulate these contracts as a blockchain transaction which is issued into blockchain via consensus protocol; the deployment of the contracts is completed once the contracting parties sign the target language contracts;
the module of contract execution and verification is used to execute the functions of the target language contract by the blockchain nodes once the corresponding terms of the smart legal contract are triggered, further issue the execution results to blockchain in a blockchain transaction form after the execution termination; the transaction is stored into blockchain as an electronic certification of contract execution after the transaction contents are validated by the consensus protocol.
